(19) United States
(12) Patent Application Publication
(10) Pub. No.: US 2011/0075413 A1
(43) Pub. Date: Mar. 31, 2011

(54) Lighting system

(76) Inventors: Gregory S. Smith, Santa Ana, CA (US); Thomas T. Nagano, Cerritos, CA (US)

(21) Appl. No.: 12/586,938

(22) Filed: Sep. 30, 2009

(51) Int. Cl. F21V 1/00; F21S 4/00

(52) U.S. Cl. 362/235; 362/249.02

(57) ABSTRACT

The present invention is an improved lighting system. In particular, the present invention is directed to an LED lighting system with replaceable circuit boards. The lighting system comprises a printed circuit board with a set of LEDs on top and two electrical contact surfaces on the bottom that snaps into a module assembly. The module assembly has an exterior element with two contact windows on its surface with a set of fingers extended to hold the circuit board to two electrical contacts. The electrical contacts pierce two electrical leads inside channels in an interior element of the module assembly.

### TECHNICAL FIELD

The present invention is an improved lighting system. In particular, the present invention is directed to an LED lighting system with replaceable circuit boards.

### BACKGROUND ART

Recently, lighting systems, in particular theater lighting systems, have begun to replace incandescent and other bulbs with light emitting diodes (LEDs.) LEDs are useful as they generally have longer life cycles than incandescent bulbs and use less energy.

However, the replacement and/or change of LEDs in existing LED systems has drawbacks. For example, LEDs are not easily removed from printed circuit boards and pronged LEDs can be difficult to remove from electric leads. The present invention provides an improved lighting system that has more easily replaceable LEDs and printed circuit boards that can also be easily configured into a variety of shapes and layouts.

### SUMMARY OF THE INVENTION

The present invention is an improved lighting system. In particular, the present invention is directed to an LED lighting system with replaceable circuit boards. The lighting system comprises a printed circuit board with a set of LEDs on top and two electrical contact surfaces on the bottom that snaps into a module assembly. The module assembly has an exterior element with two contact windows on its surface with a set of fingers extended to hold the circuit board to two electrical contacts. The electrical contacts pierce two electrical leads inside channels in an interior element of the module assembly.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a side view of a three LED embodiment of the present invention;

FIG. 2 is an exploded perspective view of a three LED embodiment;

FIG. 3 is a perspective view of an embodiment of the modular assembly mounted on electric leads;

FIG. 4 is a perspective view of an embodiment of the exterior element of the modular assembly;

FIG. 5 is a perspective view of an embodiment of the interior element of the modular assembly;

FIG. 6 is a perspective view of an embodiment of the modular assembly;

FIG. 7 is an exploded perspective view of the interior element of the modular assembly with two electric leads, electric contacts and a wedge;

FIG. 8 is a side view of a preferred installation of the invention;

FIG. 9 is a top view of a three LED embodiment of the present invention; and,

FIG. 10 is a perspective view of an alternative preferred installation of the invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide an improved lighting system.

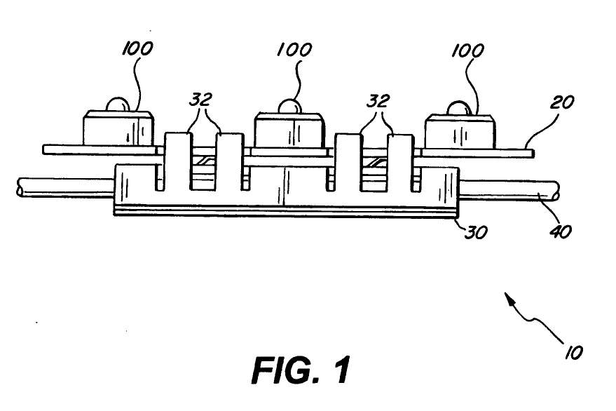

Referring now to FIG. 1, a preferred embodiment of the invention 10 is shown. A printed circuit board (PCB) 20 with three light emitting diodes 100 (LEDs) is shown in FIG. 1. However, PCB configurations of 1, 2 or more LEDS are possible.

In addition to LEDs, other electronics can also be mounted on the PCB 20. For example, a photo sensor could be mounted on the PCB 20 along with the LEDs. The photo sensor could monitor the light output of the LEDs and increase or decrease the power to the LEDs to compensate for possible degradation of the LEDs during their life span. Alternately, an infrared sensor could be mounted on the PCB to turn the LEDs on or off depending on whether people are present where the device is installed.

The PCB 20 is preferably coated to resist moisture and corrosion. The preferred coating is silicon based conformal coating such as Konform by Chemtronics. The PCB 20 is held on a module assembly 30 by a plurality of fingers 32, preferably four fingers 32, on each side of the module assembly 30. The module assembly 30 is affixed to a pair of electrical leads 40. The PCB 20 preferably has a plurality of electrical contact surfaces 22 on its bottom side. FIG. 9 is a top view of the embodiment in FIG. 1 showing the electrical contact surfaces 22 on the bottom of the PCB 20 in phantom lines. The module assembly 30 is preferably made from polycarbonate plastic with a flammability rating of FR94.

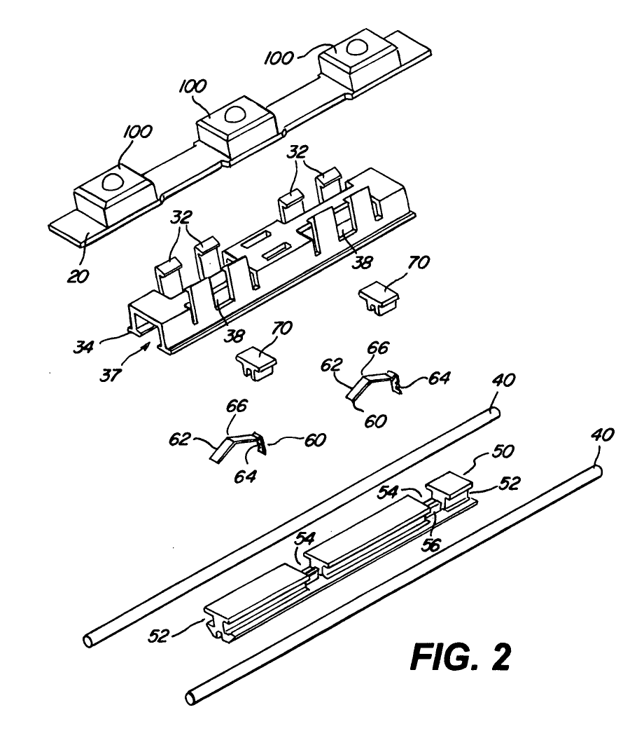

An exploded view of the embodiment in FIG. 1 is shown in FIG. 2. The module assembly 30 preferably comprises an exterior element 34 and interior element 50.

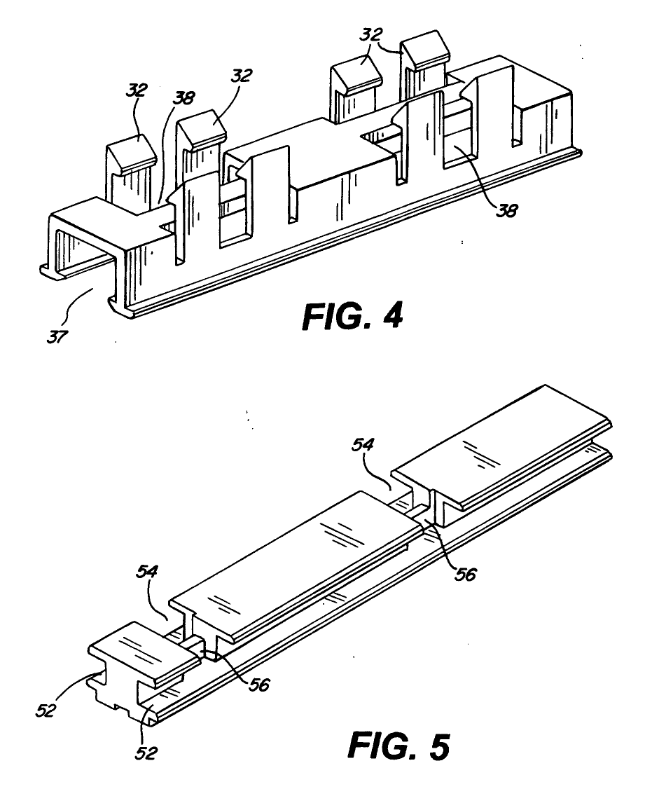

A preferred embodiment of the exterior element 34 is shown in FIG. 4. The exterior element 34 shown has a plurality of fingers 32 extending from the exterior element 34 (preferably 2 sets of four fingers as shown). The exterior element 34 shown further comprises an interior channel 37 and two electrical contact windows 38.

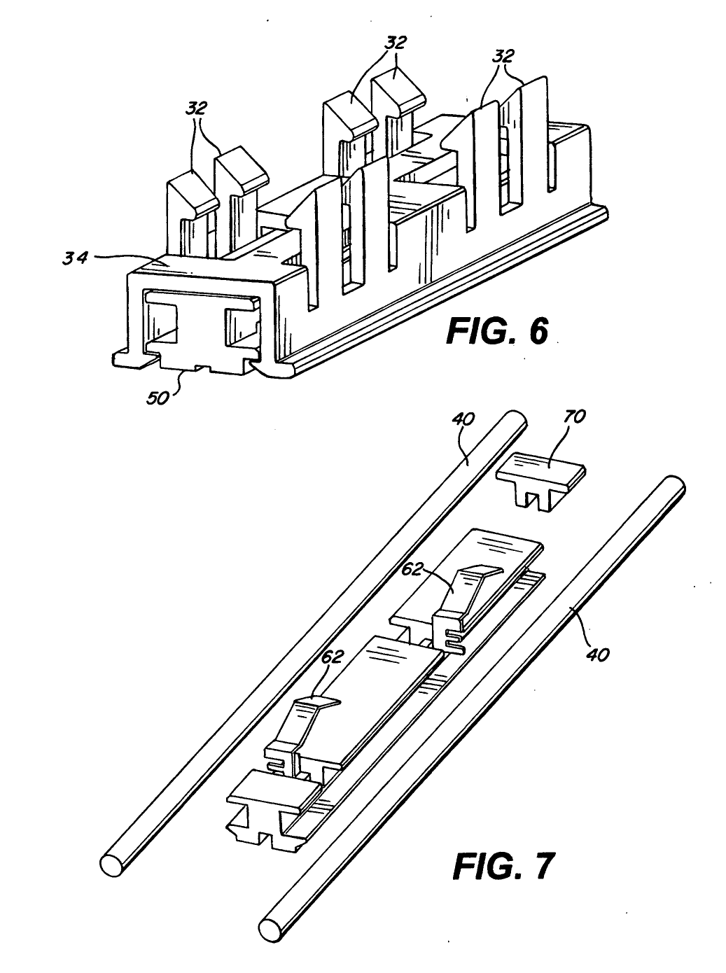

A preferred embodiment of the interior element 50 is shown in FIG. 5. The interior element 50 shown comprises two electrical lead channels 52 and electrical contact notches 54. As shown in FIG. 2, the electrical leads 40 fit into the electrical lead channels 52. As shown in FIG. 6, the interior element 50 is preferably insertable into the interior channel 37 of the exterior element 34.

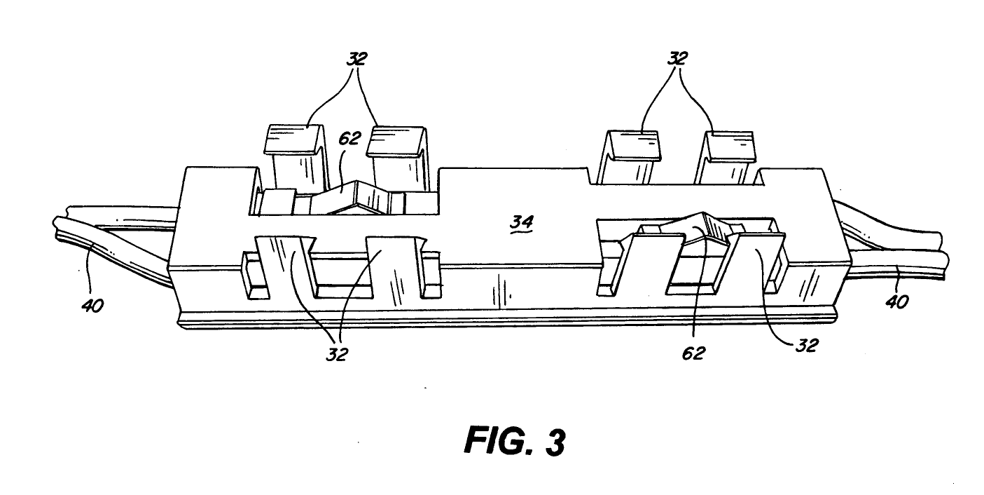

Referring back to FIG. 2, two electrical contacts 60 are shown. The electrical contacts preferably have first ends 62 that are bent, e.g. V-shaped and have second ends 64 that can pierce the electrical leads 40. As shown in FIG. 3, the first ends 62 of the electrical contacts 60 extend through the electrical contact windows 38 in the exterior element 34 of the module assembly 30. This configuration allows the plurality of fingers 32 to hold the electrical contact surfaces 22 of the PCB 20 to the first ends 62 of the electrical contacts 60 as shown in FIGS. 1 and 9. When the first ends 62 are V-shaped, the contact apex 66 makes contact with the electrical contact surfaces 22 of the PCB 20. The electrical contacts 60 are preferably flexible and provide a spring force resistant to the force of the plurality of fingers 32 applied against the PCB 20. The electrical contacts 60 are preferably made from nickel-plated brass and/or stainless steel. By placing the LEDs 100 on a separate component (PCB 20) from the electrical contacts 60, it separates the mechanical component (60) from the LEDs 100 thus reducing the chances that the LEDs 100 or other electronic component on the PCB 20 could be damaged during installation.

Referring back again to FIG. 2, the module assembly 30 preferably further comprises two wedges 70 that are insertable into the electrical contact notches 54. The wedges 70 are used to hold the electrical contacts 60 in place in the notches 54 so that the second ends 64 can pierce the electrical leads 40. The exploded view in FIG. 7 showing a portion of a preferred embodiment shows where the electrical contacts 60 are placed in the notches 54. The wedge 70 shown in FIG. 7 is then inserted into the notch 54 over the ridge 56 to hold the electrical contact 60 in place on the interior element 50 to pierce the electrical lead 40 and for placement in the exterior element 34 of the module assembly 30.

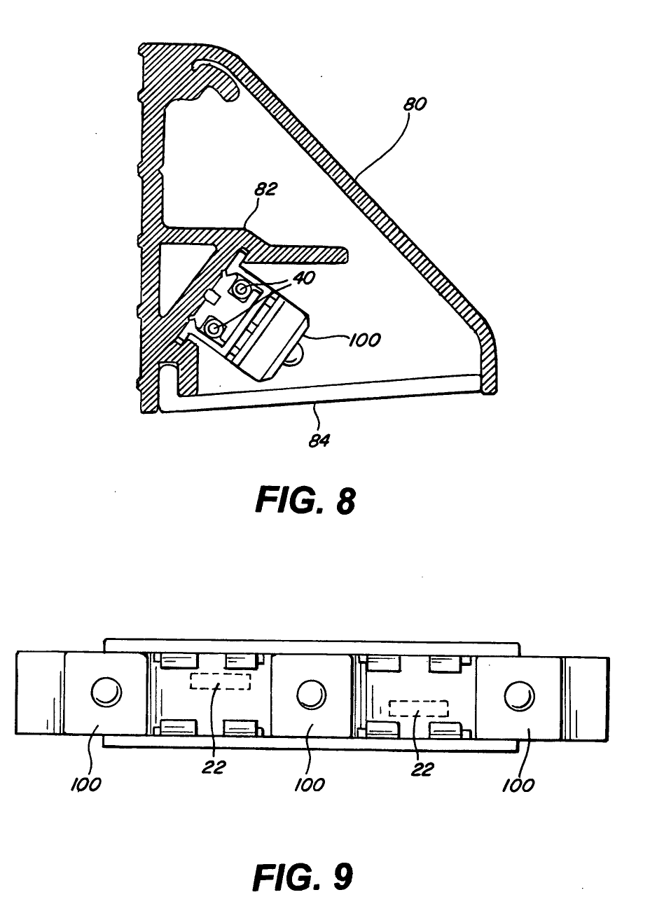

Referring now to FIG. 8, a preferred installation of the invention is shown. In FIG. 8, the PCB 20 with LED 100 is mounted on the module assembly 30 containing electrical leads 40. The module assembly 30 is then inserted into a lighting base 80 preferably having a mounting base or module assembly track 82 for holding the module assembly 30 and a lens 84. The lens 84 is preferably removable so that the PCB 20 and LED 100 can be easily removed from the module assembly for replacement or other purposes. In the embodiment shown in FIG. 8, the lighting base 80 is configured to obscure light from the LED 100 from above and to direct light downward from the base. e.g. toward a stair step or walkway in a darkened theater environment. The lens 84 is preferably polycarbonate plastic.

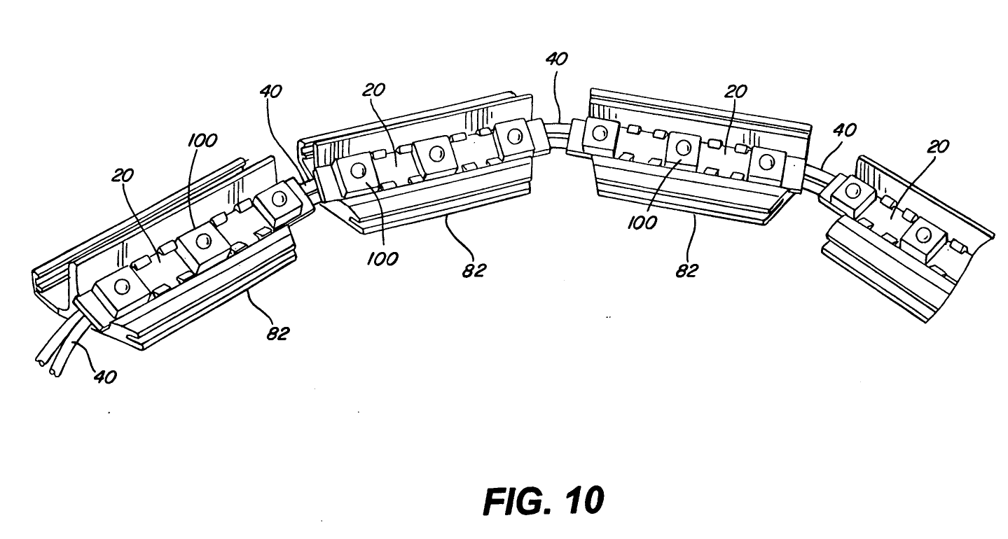

Referring now to FIG. 10, another preferred installation of the invention is shown. A cove lighting installation in an arc shape is shown in FIG. 10. As in FIG. 8, the installation in FIG. 10 has several PCBs 20 with LEDs 100 mounted on module assemblies 30 containing electrical leads 40. The module assemblies 30 are then mounted on mounting bases 82. However, as opposed to FIG. 8, the mounting bases 82 shown in FIG. 10 are not a single track but a series of bases 82 that are unconnected (except by the electrical leads 40 between the bases 82) and that can be configured in a variety of shapes and positions including, but not limited to, the arc of bases 82 shown in FIG. 10.

Thus, an improved lighting system is described above that utilizes LED printed circuit boards that are more easily replaceable and where the lighting can be readily configurable into a variety of shapes and positions. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A lighting system comprising:
a printed circuit board having at least one light emitting diode attached to a top surface and at least two electrical contact surfaces on a bottom surface;
a module assembly having an exterior element with a plurality of fingers extending from the exterior element and removably holding the printed circuit board to the exterior element, an interior channel, and at least two contact windows on a surface of the exterior element and an interior element insertable into the interior channel and having a plurality of electrical lead channels and having a plurality of electrical contact notches;
a plurality of electrical contacts where an electrical contact is placed each of the plurality of electrical contact notches of the interior element and extends through one of the contact windows of the exterior element to make contact with at least one of the electrical contact surfaces of the printed circuited board; and,
at least two electrical leads, where one electrical lead passes through the module assembly through the interior channel of the exterior element and through one of the electrical lead channels of the interior element assembly, and where one of the electrical contacts connects to the one electrical lead.

2. The lighting system of claim 1 where the plurality of electrical contacts each have an end that pierces one electrical lead to make electrical contact with the one electrical lead.

3. The lighting system of claim 1 where the plurality of electrical contacts each have an end that is bent so that the end has a contact apex.

4. The lighting system of claim 3 where the plurality of electrical contacts each have an end that is V-shaped.

5. The lighting system of claim 1 where the module assembly further comprises a plurality of wedges, where each wedge is insertable into one of the electrical contact notches against one of the electrical contacts.

6. The lighting system of claim 1 where the printed circuit board also has a photo-sensor for measuring the light output of the at least one light emitting diode.

7. A lighting system comprising:
a printed circuit board having at least one light emitting diode attached to a top surface and two electrical contact surfaces on a bottom surface;
a module assembly having an exterior element and an interior element, where the exterior element has a plurality of fingers extending from the exterior element and removably holding the printed circuit board to the exterior element, an interior channel, and two contact windows on a surface of the exterior element, and where the interior element is insertable into the interior channel and has two electrical lead channels and two electrical contact notches;
two electrical contacts, where one electrical contact is placed in each of the electrical contact notches of the interior element and extends through one of the contact windows of the exterior element to make contact with one of the electrical contact surfaces of the printed circuited board; and,
two electrical leads, where each of the electrical lead passes through the module assembly through the interior channel of the exterior element and through one of the electrical lead channels of the interior element assembly, and where one of the electrical contacts connects to one of the electrical leads.

8. The lighting system of claim 7 where each of the electrical contacts are flexible and has a first and a second end, where the first end pierces one of the electrical leads and the second end is bent and has a contact apex that makes contact with one of the electrical contact surfaces of the printed circuit board.

9. The lighting system of claim 8 where the second end is V-shaped.

10. The lighting system of claim 7 where the module assembly further comprises two wedges, where each wedge is insertable into one of the electrical contact notches against one of the electrical contacts.

11. The lighting system of claim 8 where the plurality of fingers of the exterior element of the module assembly hold the two electrical contact surfaces of the printed circuit board against the contact apex of the two electrical contacts.

12. A lighting system comprising:
a lighting base having a lens and a module assembly track;
a printed circuit board having at least one light emitting diode attached to a top surface and two electrical contact surfaces on a bottom surface;
a module assembly having an exterior element and an interior element, where the exterior element has a plurality of fingers extending from the exterior element and holding the printed circuit board to the exterior element, an interior channel, and two contact windows on a surface of the exterior element, and where the interior element is insertable into the interior channel and has two electrical lead channels and two electrical contact notches, where the module assembly is insertable into the module assembly track;
two electrical contacts, where one electrical contact is placed in each of the electrical contact notches of the interior element and extends through one of the contact windows of the exterior element to make contact with one of the electrical contact surfaces of the printed circuited board; and,
two electrical leads, where each of the electrical lead passes through the module assembly through the interior channel of the exterior element and through one of the electrical lead channels of the interior element assembly, and where one of the electrical contacts connects to one of the electrical leads.

13. The lighting system of claim 12 where the module assembly is connected to the module assembly track by the exterior element of the module assembly.

14. The lighting system of claim 12 where each of the electrical contacts are flexible and has a first and a second end, where the first end pierces one of the electrical leads and the second end is bent and has a contact apex that makes contact with one of the electrical contact surfaces of the printed circuit board.

15. The lighting system of claim 14 where the plurality of fingers of the exterior element of the module assembly hold the two electrical contact surfaces of the printed circuit board against the contact apex of the two electrical contacts.

16. The lighting system of claim 14 where the first end of each electrical contact pierces one of the electrical leads with at least one tooth.
